(19) United States
(12) Patent Application Publication
(10) Pub. No.: US 2005/0010515 A1
(43) Pub. Date: Jan. 13, 2005

(54) Method of identifying high value patents within a patent porfolio

(75) Inventor: Jurgen Woltjen, Erlangen (DE)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 10/615,068

(22) Filed: Jul. 8, 2003

(51) Int. Cl. G06F 17/60

(52) U.S. Cl. 705/36

(57) ABSTRACT

The present invention provides a fast, simple and accurate method of identifying high value patents from within a patent portfolio, furthermore the invention can also be used to identify potential parties which could be interested in a patent, e.g. for buying it. To identify high value patents quantified parameters will be determined and assigned to the patents from within a patent portfolio. After the assessment of the overall quantified value of each patent and the ranking of the patents in respect of the overall value it is easy to identify high value patents.

### FIELD OF THE INVENTION

The present invention relates in general to a method of identifying patents and more specifically to a method of identifying high value patents from within a patent portfolio using quantified parameters.

### BACKGROUND OF THE INVENTION

Companies are increasingly discovering that their intellectual property is an abundant wellspring of earnings as well as a powerful negotiable resource. As such it is well known that certain patents are highly valued by certain companies or constitutions. High value patents have a variety of uses, such as providing exclusive rights, cross license potential, and corporate valuation. Many large companies or constitutions have large portfolios of patents. However, problems exist in identifying specific patents from within this portfolio or other portfolios which are of high value. Therefore, there is a need to identify high value patents from within a patent portfolio and especially from within large patent portfolios.

In the past, identification of high value patents was an onerous, expensive and time consuming work. Experts in the related technical field typically analyzed the subject matter and claim scope of each patent as well as the potential interest third parties may have for the patent. This method was commonly performed manually using tools such as feature analysis.

Identifying high value patents from a portfolio is normally a very subjective matter, depending on the different experience, expertise and mood of the expert conducting this. The identification of high value patents within a portfolio is further complicated because internal and external factors may change the classification of patents as being “high value” or not. For example, internal impacts could be a company's new products or new market strategies. For another example, external impacts could be a competitor's new products or changing customer demands. Therefore there is a need for a continuous, quick, cheap and easy to identify high value patents.

More recently, attempts have been made to evaluate via computer. However, these approaches tend to be ineffective and provide inaccurate results. There is therefore a need for a fast, simple and accurate method to identify high value patents from within a patent portfolio and there is also a need to easy update identified high value patents and other identified patents.

### SUMMARY OF THE INVENTION

The present invention provides a fast, simple and accurate method of identifying high value patents from within a patent portfolio.

One aspect of the present Invention thus involves a method of identifying high value patents in a patent portfolio, comprising: identifying a patent portfolio; assigning a plurality of parameters to substantially all patents of the patent portfolio; determining an overall quantified value of at least one patent within the patent portfolio based on the assigned parameters; identifying the high value patents according to the overall quantified value.

A second aspect of the present invention thus involves a computer system for identifying high value patents in a patent portfolio, wherein each patent is represented by a data record, comprising: means to obtain access to internal or external data bases to provide the patent portfolio; at least one computer unit with input means; output means; means to assign quantified parameters to at least one data record based upon; means to determine an overall quantified value of at least one patent within the patent portfolio based on the quantified parameters; means to identify high value patents according to the overall value.

Another aspect of the present invention involves a computer program stored in a computer system or a computer readable medium for identifying high value patents in a patent portfolio, wherein each patent is represented by a data record, comprising: quantified parameters; bibliographic data; and at least one indicator for high value patents.

Further aspects, features and advantages of the present invention will become apparent from the drawings and detailed description of the following preferred embodiments. The invention can also be used to identify potential parties which could be interested in a patent, e.g. for buying it.

### BRIEF DESCRIPTION OF THE DRAWINGS

The above-mentioned and other concepts of the present invention will now be addressed with reference to the drawings of the preferred embodiments of the present invention. The shown embodiments are intended to illustrate, but not to limit the invention. The drawings contain the following figures, in which like numbers refer to like parts throughout the description and drawings and wherein:

FIG. 1 is a flowchart of an exemplary process of the present invention showing an exemplary series of steps to identify high value patents from within a patent portfolio;

FIG. 2 is a schematic diagram of an exemplary data record of a database containing a patent portfolio;

FIG. 3 a schematic diagram of a computer system adapted to implement an embodiment of the invention;

### DETAILED DESCRIPTION OF THE PREFERRED EMBODIMENT

Overview

The disclosed invention advantageously employs one or more base concepts.

One concept is the patent portfolio. As is well known, large numbers of patents (e.g. 100-10,000 or more) are often organized within one portfolio, where the patents are typically classified and categorized e.g. regarding technology, ownership, market segments, projects, products etc. Smaller numbers of patents (e.g. 2-100) may also be similarly organized.

Another concept used in connection with the invention is that some patents of a portfolio are regarded as high value patents. For example, high value patents may be pioneer patents, patents with broad claims, or patents in profitable technological or business areas, or patents which provide a significant competitive advantage.

Another concept is the use of quantified parameters to identify high value patents. Quantified parameters are properties of a patent which are readily discrete, determinable or measurable. For example, the age of a patent or the fact that the patent has survived a reexamination proceeding represent quantified parameters.

A further concept of the invention relates to the identification of high value patents from within a patent portfolio based on the use of quantified parameters. One way by which this identification can be achieved is the use of a mathematical algorithm or equation to rank the patents based on the quantified parameters.

As will be understood by those skilled in the art, the invention described is not limited to granted utility patents, but is also applicable to design patents, utility models, patent applications and the like. The invention also has uses outside the scope of patents, such as other types of intellectual property or other assets, however, the invention is particularly applicable to patents.

As previously noted, the concept of structuring patents in portfolios is well-known. A patent portfolio can span a large number of patents (e.g. 100-10,000 or more) or contain only a few patents (e.g. 2-100).

The patents of a patent portfolio are rarely considered to have the same value. The most valuable patents of a portfolio can be considered high value patents. For example, pioneer patents or patents with broad claims are typically regarded as high value patents. These patents tend to interfere with competitors' businesses, since competitors have to design their products or services around these patents, take a license under the patents, provide infringing products or services, or invalidate the patents. A pioneer patent normally covers features which offer a unique selling position and competitive advantage to its owner. For example, some patents by the inventors George Westinghouse and Werner von Siemens are regarded as pioneer patents. Another aspect of high value patents involves their weight and relevance in cross licensing negotiations and in mergers and acquisitions since patents may also be regarded are regarded as a business tool strategy and as a form of currency. High value patents may also be a source of royalty income in form of.

The use of quantified parameters allows this identification procedure more automated and objective. Also subsequent identifications of high value patents are more consistent, coherent, measurable, reproducible and traceable because subjective influences are diminished, if not eliminated and each identification proceeding is based on the same or similar defined quantified parameters.

An example of a quantified parameter is, whether a patent survived an opposition, a reexamination, or a nullity procedure. The fact that a patent overcame an opposition, a reexamination, or a nullity procedure indicates that the patent overcame at least two examination procedures (the original examination and the subsequent procedure) and that the patent has the interest of a competitor or third party. Thus, the patent can be considered of higher value relative to otherwise equal patents that did not undergo such a procedure, and therefore these procedures provide an objective quantified parameter to help identify high value patents. In countries or patent systems which do not have an opposition procedure (e.g. the USA) other comparable procedures can be taken into regard, e.g. interference procedure.

The following assignment table table 1 shows one suitable way how to use a quantified parameter to obtain a number to a patent which overcame a reexamination and a nullity procedure. If the patent overcame the reexamination proceeding and was maintained with no additional limitations or no significant limitations that diminished the value of the patent, the patent may be assigned the quantified number 3, if there was a significant limitation the patent may be assigned the quantified number 1 and if the opposition, reexamination or nullity procedure resulted in a medium scale limitation the patent may be assigned the quantified number 2. The higher the assigned number the higher is the weighting for the patent under consideration (and vice versa). Instead of numbers, the quantified parameters can be used to generate letters or symbols e.g. A, B, C, ↑, -, ↓, [symbol] . Such letters or symbols can also be used to indicate a ranking.

TABLE 1
Determination of a quantified parameter based upon a
patent overcame a reexamination or a nullity procedure

| Opposition or Reexamination | | | Nullity | | |
|---|---|---|---|---|---|
| No limitation | | | No limita- | | |
| or no | Medium | | tion or no | Medium | |
| significant | scale | significant | significant | scale | significant |
| limitation | limitation | limitation | limitation | limitation | limitation |
| 3 | 2 | 1 | 3 | 2 | 1 |

Referring to table 2, another quantified parameter that can be used in context of the present invention is the citation index, or how often the patent or one of the family members of the patent was cited by other patents or patent applications. In a further refinement, the citation by 3^{rd} party patents or patent applications could be used to provide a higher value than citations by self originated patents since third parties may be more objective and may be interested in the cited patent.

TABLE 2
Determination of a quantified parameter based upon a patent
was cited in another patent or patent application

| Number of citations | Assigned number |
|---|---|
| 0 | 0 |
| 1 | 1 |
| 2-5 | 5 |
| more than 5 | 10 |

Referring to table 3 another quantified parameter that can be used in context of the present invention is the age of a patent. Since older patents have higher maintenance fees and are presumably more closely scrutinized prior to paying such fees, the age of a living patent can be considered a quantified parameter. The assignment of a quantified number to a patent on the basis of age could be done in several ways. For example, the age of one year could mean assignment of number 1, age of two years means assignment of number 2, and so on. Of course other more sophisticated approaches could be used. For example, as of a defined age “n” the assigned number will be 1 and patents which are younger than this defined age could be assigned the number 0. To determine a suitable number “n” for the age the entire or a sample of the underlying portfolio could be analyzed by using the other quantified parameters and determine which number “n” yields nearly the same high value patents. Also the number “n” need not to be the same throughout the entire portfolio and may depend on the underlying technology, lifecycle of affected products etc.

Another example of quantified parameter correlates to the amount of money which has to be paid to the patent office to maintain a patent. This approach takes into account that the relationship between the age of a living patent and the maintenance fees are not in a direct ratio but in a more exponential ratio. A further example of quantified parameter correlates to the number of countries in which the patent has been filed.

TABLE 3
Determination of a quantified parameter based upon the age of a
patent or patent application, wherein the assigned number
correlates directly to the age

| Age | Assigned number |
|---|---|
| 1 | 1 |
| 2 | 2 |
| 3 | 3 |
| n | n |

The more quantified parameters used for identifying high value patents the more accurate the result will tend to be, especially in regard to consistency and coherence since deviations originated in subjective identification criteria are diminished, if not eliminated. The invention is not limited using the exemplary quantified parameters described above and those skilled in the art will readily understand other quantified parameters that could be used.

The quantified parameters are preferably used within a formula or algorithm that determines an overall quantified value of each patent from within the portfolio. For example, the overall quantified value “Qₐₗₗ” of a patent can be determined using the following formula, where Q₁ means the quantified parameter based on overcoming of a reexamination procedure, Q₂ means the quantified parameter based on the number of citations and Q₃ means the quantified parameter based on the patent age:
Qₐₗₗ=Q₃*(Q₁+Q₂)

Thus the the overall quantified value Qₐₗₗ of the patent can be objectively determined. Of course, as will be understood by those skilled in the art, any suitable algorithm that adds, multiplies, subtracts and/or divides values provided by the quantified parameters. Furthermore, a scale factor for one or more quantified parameters could be used in the calculation of the overall quantified value Qₐₗₗ.

As also will be understood by the person skilled in the art, other parameters based on more subjective decisions can be used to determine the overall quantified value Qₐₗₗ of a patent. For example, a value coming out of the decisions of an evaluation board can additionally be used to determine the overall quantified value Qₐₗₗ.

In addition to identify high value patents, the overall quantified value Qₐₗₗ could be used to identify low value patents that could then be abandoned to save the maintenance fee expenses.

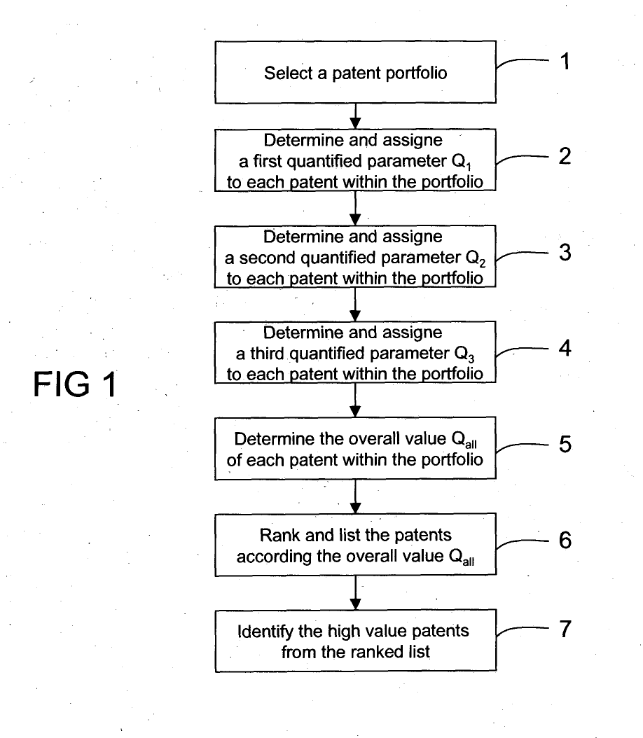

FIG. 1 depicts a flowchart showing a series of exemplary steps that can be performed to identify high value patents. In step 1 the applicable patent portfolio is selected. The portfolio can be based on technology (e.g. power generation patents), product driven (e.g. turbine blades), company driven (e.g. Siemens Westinghouse Power Corporation) etc. The portfolio may be public (e.g. Derwent™ data base 9) or private (e.g. proprietary data base 8). Access to the commercial data base 9 of a commercial is typically established via a network 10, (e.g. the Internet), see FIG. 3.

In the next step 2, a first quantified parameter Q₁ is determined and assigned to at least one patent, preferably all patents, from within the portfolio.

In the next step 3, a second quantified parameter Q₂ is determined and assigned to at least one patent, preferably all patents, from within the portfolio.

In the next step 4, a third quantified parameter Q₃ is determined and assigned to at least one patent, preferably all patents, from within the portfolio.

In the next step 5, the overall quantified value Qₐₗₗ of each patent within the patent portfolio is determined, using a method of computation, e.g. Qₐₗₗ=Q₃*(Q₁+Q₂).

In the next step 6, the patents within the patent portfolio are ranked and listed according the overall quantified value Qₐₗₗ.

In the next step 7, the identification of high value patents will be accomplished. For example, the high value patents could be on the top of the list, highlighted or marked (e.g. using letters or symbols).

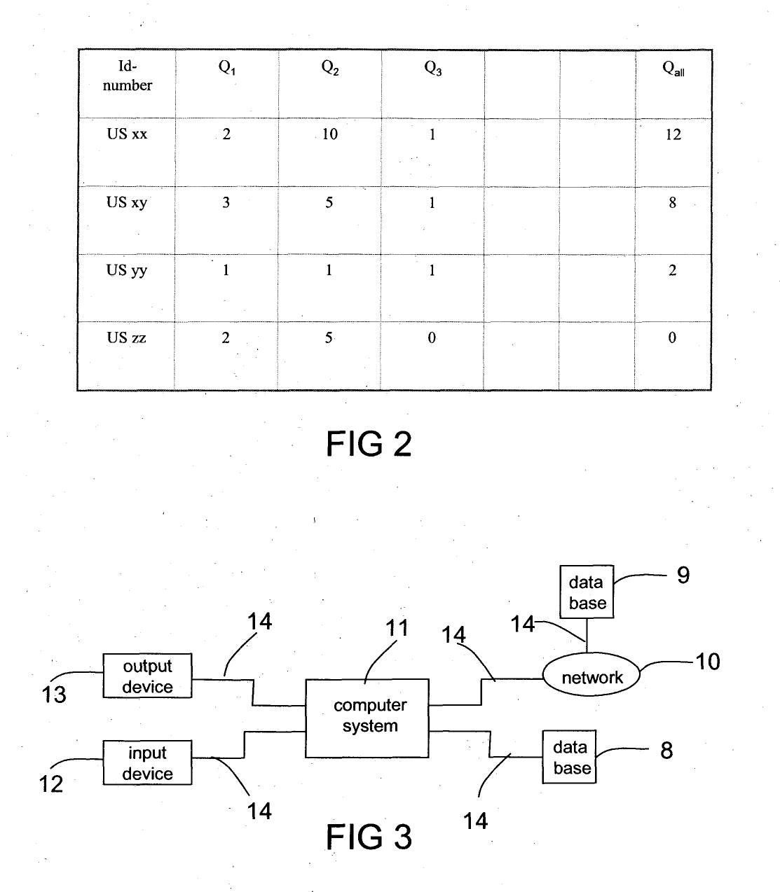

FIG. 2 shows an exemplary data record that could be used as part of a computer database or program, as explained in more detail below. The data record is depicted as a table where each row contains a data record for each patent within the portfolio. The first row of the table shows the attributes of the data records. In the table are exemplarily shown an identification number (Id-number), the quantified parameters Q₁, Q₂, Q₃ and the overall quantified value Qₐₗₗ. The empty columns indicate that the data record could contain further attributes (e.g. bibliographic data). Furthermore it would be useful that the date record also contains information about an opponent or about the patents in which a patent was cited or about the applicant or the proprietor of these patents.

To identify a high value patent in the portfolio exemplarily depicted in FIG. 2 the patents have been ranked, ordered and listed based on their overall quantified value Qₐₗₗ. The value Qₐₗₗ is called an overall quantified value, because its determination is substantially based upon quantified parameters. In FIG. 2 the overall quantified value Qₐₗₗ was determined using the equation Qₐₗₗ=Q₃*(Q₁+Q₂). The high value patents are at the head of the list. At the bottom of the list you can find patents of lower value. These patents could be candidates to abandon, to save for example maintenance fees. The parameters Q₁, Q₂ and Q₂ are used exemplarily for convenience of understanding. One can use any numbers of parameters. Typically 1 to 50 parameters will be used to determine the overall quantified value Qₐₗₗ. With computer support even more than 50 parameters can be taken into regard.

A further aspect of the invention is that the invention can be used to identify third parties for which a patent from within the portfolio could be of interest. The considered information about oppositions and citations is a good indicator for parties for which a patent is of interest.

FIG. 3 exemplarily depicts a computer system 11 which can be used to identify high value patents automatically. The computer system 11 could be a Personal Computer, a workstation or a system consisting of more than one single computer unit which are linked together, e.g. a client-server-system with a plurality of users. Thus the computer system 11 can be designed as a one computer system or as a distributed system, e.g. a client-server-system. Furthermore the computer system 11 contains input means 12 such as keyboard and mouse and output means 13 such as monitor, printer etc. Furthermore the computer system has access to internal data bases 8 and external data bases 9. The access to external data bases 9 could be accomplished e.g. via an external network for example the Internet. The elements of the system are connected via wired or non wired interfaces 14. For example an external data base 9 could come from Derwent™ or an other patent information provider. The underlying program code and the used data records could exemplarily implemented by any conventional programming language e.g. C, C++ or Java. Especially Java and Markup Languages, e.g. HTTP (Hypertext Transfer Protocol) or XML (Extended Markup Language) for implementing data records are especially useful to support operating via an intranet or via the Internet. The connection to the data bases 8, 9 providing the patents for the patent portfolio can be offline or online, depending e.g. on the frequency of the need of identifying high value patents.

To compute and identify the high value patents conveniently a spread sheet program can be used, if the selected portfolio is imported out of a data base 8, 9 into the spread sheet program. This is rather easy to accomplish, because offer interfaces to spread sheet programs. Determination and assignment of quantified parameters, at 2, at 3 and at 4 is easily achieved using the standard functionality (e.g. drag & drop) of spread sheet programs and standard input devices 14 (e.g. mouse, keyboard). Furthermore the determination of the overall quantified value Qₐₗₗ of a patent, at 5, the ranking and listing of the patents within the portfolio according the overall quantified value Qₐₗₗ, at 6, and the determination of the high value patents out of the list, at 7, are easily accomplished using spread sheet programs. Normally you will assign quantified parameters to substantially all or even all patents from within the portfolio, but it could be that it is not necessary to assign quantified parameters to all patents, e.g. if it is clear that certain patents of the portfolio should be disregarded for certain reasons. For example, a reason can be that only patents filed in certain countries should taken into regard.

The method disclosed in this invention can be implemented in a computer program to control a computer system 11 to perform the disclosed invention. The computer program can be stored in the memory and RAM of the computer system or on a computer readable medium, e.g. CD or floppy disc. Computer readable mediums can easily be distributed as merchandise.

In addition to the embodiments of the aspects of the present invention described above, those of skill in the art will be able to arrive at a variety of other arrangements and steps which, if not explicitly described in this document, nevertheless embody the principles of the invention and fall within the scope of the appended claims. Foe example, the ordering of method steps is not necessarily fixed, but may be capable of being modified without of departing from the scope and spirit of the present invention.

1. A method of identifying high value patents in a patent portfolio, comprising:
identifying a patent portfolio;
assigning a plurality of parameters to substantially all patents of the patent portfolio;
determining an overall quantified value of at least one patent within the patent portfolio based on the assigned parameters;
identifying the high value patents according to the overall quantified value.

2. The method according to claim 1, wherein the parameters are quantified.

3. The method according to claim 2, wherein the quantified parameter is based upon if the patent overcame an opposition, a reexamination or a nullity procedure.

4. The method according to claim 2, wherein the quantified parameter is based upon the patent has been cited in another patent or patent application.

5. The method according to claim 2, wherein the quantified parameter is based upon the age of the patent.

6. The method according to claim 1, wherein the parameter is assigned to all patents.

7. The method according to claim 1, wherein the patents are ranked according their overall quantified value.

8. The method according to claim 7, wherein the high value patents are listed at the top of a ranking.

9. The method according to claim 1, wherein identified high value patents are highlighted.

10. The method according to claim 9, wherein the highlighting is based upon colors.

11. The method according to claim 9, wherein the highlighting is based upon symbols.

12. A computer system for identifying high value patents in a patent portfolio, wherein each patent is represented by a data record comprising:
means to obtain access to internal or external data bases to provide the patent portfolio;
at least one computer unit with
input means;
output means;
means to assign quantified parameters to at least one data record based upon;
means to determine an overall quantified value of at least one patent within the patent portfolio based on the quantified parameters;
means to identify high value patents according to the overall value.

13. The computer system according to claim 12, wherein the computer system consists of a plurality of computers.

14. The computer system according to claim 12, wherein the computer system is connected to a plurality of data bases providing patents to be identified.

15. A computer program stored in a computer system or a computer readable medium for identifying high value patents in a patent portfolio, wherein each patent is represented by a data record comprising:
quantified parameters;
bibliographic data; and
at least one indicator for high value patents.

16. The computer program according to claim 15, wherein the computer program is implemented in Java.

17. The computer program according to claim 15, wherein the computer program is implemented in a conventional spread sheet program.

18. The computer program according to claim 15, wherein the data record is implemented in a Markup Language.

19. The computer program according to claim 18, wherein the data record is implemented in the Markup Language XML.
